(19) United States
(12) Patent Application Publication
(10) Pub. No.: US 2013/0015666 A1
(43) Pub. Date: Jan. 17, 2013

(54) HORIZONTAL-AXIS WIND TURBINE

(71) Applicant: David Gordon Wilson, Winchester, MA (US)

(72) Inventor: David Gordon Wilson, Winchester, MA (US)

(73) Assignee: MASSACHUSETTS INSTITUTE OF TECHNOLOGY, Cambridge, MA (US)

(21) Appl. No.: 13/545,027

(22) Filed: Jul. 10, 2012

Related U.S. Application Data
(60) Provisional application No. 61/506,690, filed on Jul. 12, 2011.

(51) Int. Cl. F03D 9/00

(52) U.S. Cl. 290/55

(57) ABSTRACT

Improved wind turbine. The turbine includes a rotor supporting a plurality of blades for receiving wind, and means are provided for supporting magnets or high-permeability iron to rotate with the blades and located at the periphery of the blade tips. Stator stricture is located proximate to the blade tips to interact with the magnets or iron to generate electricity.

This application claims priority to provisional application Ser. No. 61/506,690 filed on Jul. 12, 2011, the contents of which are incorporated herein by reference.

### BACKGROUND OF THE INVENTION

This invention relates to wind turbines and more particularly to a wind turbine having no gear transmission and no generator located in the turbine nacelle.

Horizontal-axis wind turbines typically have a nacelle that supports the turbine blades for rotation. The nacelle usually contains an electrical generator and a geared transmission to step up the angular velocity of the generator rotor as compared to the relatively low angular velocity of the turbine blades. Thus, such a nacelle is very heavy and the geared transmission results in gear losses that degrade efficiency.

A geared transmission is required in conventional horizontal-axis wind turbines for the following reason. The optimum blade tip speed for a two or three-bladed turbine is about five times the wind speed. Wind turbines generally operate at up to a maximum wind speed of about 20 meters per second (44 miles per hour). The blade speed at the tip is then around 100 meters per second, regardless of turbine size, for optimum performance. A large turbine rotates slowly and a small turbine has a higher rotating speed, even if the blade tip speed is the same in the two cases.

The diameter of the rotor of a nacelle-mounted generator is a small fraction of that of the blade tips, perhaps one-tenth or one-twentieth the diameter. If the generator were directly coupled to the turbine, rotor, the generator rotor would have a maximum peripheral speed of 5-10 meters per second. This low speed would require a large and heavy generator for a specified power output. The optimum peripheral speed of generator rotors is approximately 100 meters per second. To allow a near-optimum generator to be used, a step-up transmission of around 20:1 is required. Some wind-turbine gear transmissions have step-up ratios of over 100.

It is therefore an object of the invention to provide an improved horizontal-axis wind turbine that does not require a gear transmission and which locates the generator apart from the nacelle. By eliminating the transmission and locating the generator away from the nacelle, the complete turbine, according to the invention, can be considerably lighter and smaller and of higher efficiency as compared with prior-art wind turbines.

### SUMMARY OF THE INVENTION

The wind turbine according to the invention includes a rotor supporting a plurality of blades for receiving wind. Means are provided for supporting magnets or high-permeability iron to rotate with the blades and located at the periphery defined by the blade tips. Stator structure is located proximate to the blade tips to interact with the magnets or iron to generate electricity. In a preferred embodiment, the supporting means includes a circular shroud around the blade tips to carry the magnets or iron. In another embodiment, the support means are the blade tips themselves to which the magnets or iron are attached.

In this embodiment, the rotor is supported by a nacelle mounted on an upper column that is preferably tubular and streamlined. This upper column, which at its lower end carries the stator structure, is supported on a lower, fixed, column by a bearing or bearings that allow rotary motion of the nacelle, the turbine itself, and the stator structure, to face the wind. It is preferred that the magnets or iron extend all the way around the rotating shroud. When the supporting structure is the blade tips themselves, it is preferred that tensioning wires be provided to connect the blade tips. In this embodiment it is preferred that the stator comprise an arc-shaped structure supporting the stator components. In a preferred embodiment, the rotor includes three blades and the arc-shaped structure extends approximately 60 degrees on both sides of the upper column so that at least one blade tip is always proximate the arc-shaped stator.

As mentioned above, by eliminating a geared transmission, overall efficiency is higher because of the elimination of gear losses. The wind turbine of the present invention is likely to be more highly reliable because the step-up gear transmission in known wind turbines is the principal cause of turbine downtime. The present generator is also considerably easier to service since the stator is located nearer to the ground than if it were located in the nacelle. It is also likely to he less susceptible to lightning strikes,

### BRIEF DESCRIPTION OF THE DRAWING

FIG. 1 is a schematic illustration of an embodiment of the invention disclosed herein using a rotating shroud.

FIG. 2 is a schematic illustration of an embodiment of the invention in which magnets are carried on the rotor tips and the stator includes an arc-shaped structure located near the rotor tips.

### DESCRIPTION OF THE PREFERRED EMBODIMENT

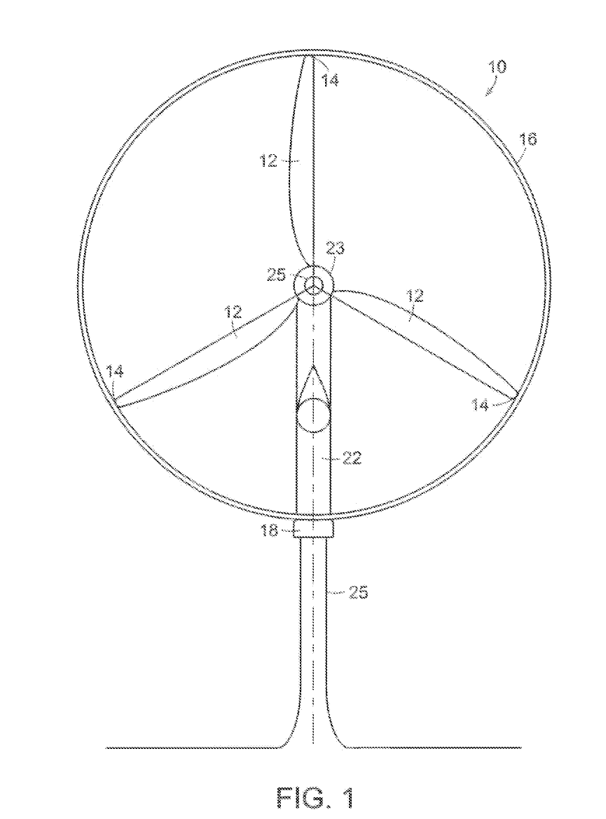

With reference first to FIG. 1, a wind turbine 10 includes three blades 12 having tips 14. A rotating shroud 16 is mounted around the turbine blade tips 14. The shroud 16 supports magnets, conductors, or high-permeability stacks of iron all the way around the rotating shroud 16 in such a way that they pass through an appropriate stationary device (stator) to generate current as occurs in traditional electrical generators. In this embodiment, a stator 18 is mounted on an upper column 22 that swivels with a change in wind direction on a bearing or bearings on a stationary column 20 supporting the whole wind-turbine structure.

In the embodiment of FIG. 1, as the shroud 16 rotates with the blades 12, the interaction of magnets or other components in the shroud with the stator 18 generates electricity. The upper column 22 connects a nacelle 23 to the stator 18, The blades themselves are normally adjustable in the angle they present to the wind by a mechanism enclosed in the turbine hub 25.

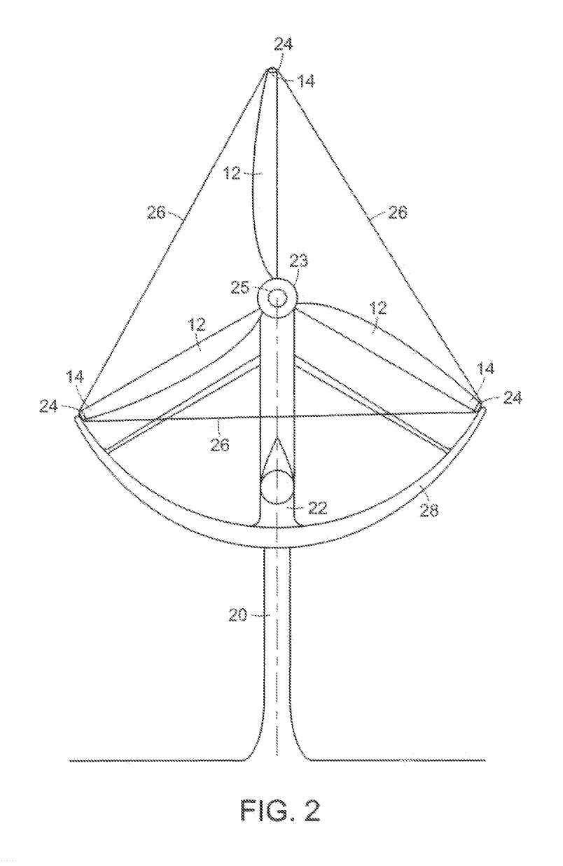

With reference now to FIG. 2, another embodiment of the invention includes the three blades 12 with magnets or stacks of iron 24 attached to the blade tips 14. In the embodiment of FIG. 2, three blades 12 are illustrated. Turbines may have more or fewer blades than the three blades illustrated. In this case, an arc-shaped structure 28 forming the stator should span approximately 60 degrees on each side of the upper column 22 so that at least one of the magnets 24 is proximate the arc-shaped structure 28 at all times. Because at least one of the blades 12 is sweeping past the stator 28 at all times, electricity is continuously generated. The magnets or stacks of iron 24 should either be of a circular cross-section so that they would be unaffected by the blade rotation on its own axis, or they could be held orthogonal to the stator 28 by a rotationally stiff tubular structure internal to the blade and connected to the hub 25 in such a way as to maintain the orientation of the magnets or stacks of iron 24, or these may be rotated relative to the blade tips by automatic mechanisms to maintain their orientation.

The improved wind turbine disclosed herein should result in a system that is considerably more reliable and possibly more efficient and lower in cost to erect and to service in comparison with existing wind-turbine systems. In both of the embodiments disclosed herein, the stator components of the generator are mounted at or near the lower end of an upper column that is supported by bearings by the main (lower, fixed) turbine column so that it is oriented correctly to the plane of the blades. The upper column could be airfoil shaped and thus have lower drag and produce reduced buffeting and thereby lower blade stresses and lower noise.

The blades 12 may be made of any suitable material such as resin reinforced with glass or carbon fibers. Under wind loading, the blades may deform resulting in a misalignment with the stator structure. The blades 12 could be stiffened by guy wires extending to a forward bowsprit (not shown) on the turbine axis. Alternatively, the blade-tip magnets, iron armatures or copper windings may move axially under automatic control to restore rotor-stator alignment. Similarly, the stator components could be mounted on fore-and-aft sliders under automatic control to assure proper alignment with the blade tips.

The main (lower, fixed) support column 20 could be considerably shorter than in conventional wind turbines, terminating in a substantial bearing or bearings connecting it with the upper column 22 and stator in both embodiments and permitting relative rotation. This arrangement should also reduce the costs of turbine erection and maintenance compared with the costs for conventional turbines. The bearing design could also include slip rings for delivering power from the stator that must swivel to follow changes in wind direction.

It is recognized that modifications and variations of the invention disclosed herein will be apparent to those of ordinary skill in the art and it is intended that all such modifications and variations be included within the scope of the appended claims.

What is claimed is:

1. Wind turbine comprising:
a rotor supporting a plurality of blades for receiving wind;
means for supporting magnets or high-permeability iron to rotate with the blades and located at the periphery defined by the blade tips; and
stator means located proximate the blade tips to interact with the magnets or iron to generate electricity.

2. The wind turbine of claim 1, wherein the supporting means includes a circular shroud around the blade tips.

3. The wind turbine of claim 1, wherein the supporting means are the blade tips themselves.

4. The wind turbine of claim 1, wherein the rotor is supported by a nacelle mounted on an upper column, that also supports the stator.

5. The wind turbine of claim wherein the magnets or iron extend substantially all the way around the rotating shroud.

6. The wind turbine of claim 3, further including tensioning wires connecting the blade tips.

7. The wind turbine of claim 3, wherein the stator comprises an arc-shaped structure supporting stator components,

8. The wind turbine of claim 3, wherein the rotor includes three blades and the arc-shaped structure extends approximately 60 degrees on either side of the upper column so that at least one blade tip is always proximate the stator.
